(19) United States
(12) Patent Application Publication
(10) Pub. No.: US 2002/0091567 A1
(43) Pub. Date: Jul. 11, 2002

(54) System and method for electronically redeeming coupons

(76) Inventor: Tymarshall E. Royston, Memphis, TN (US)

Correspondence Address: HARSHAW RESEARCH INCORPORATED, P O BOX 418, OTTAWA, KS, 66067, US

(21) Appl. No.: 09/757,353

(22) Filed: Jan. 9, 2001

(51) Int. Cl. G06F 17/60

(52) U.S. Cl. 705/14; 705/23

(57) ABSTRACT

A method and system for processing and redeeming coupons comprises a host computer connected to a database of coupon card accounts associated with a plurality of coupon cards. Each account includes at least a consumer identifier, consumer-selected coupons, and a consumer-selected vendor identifier. At least the consumer identifier and coupon data is magnetically stored on a respective card. A coupon card account may be established from a remote computer connected to the host computer via a computer network or through a remote point-of-purchase machine. The host computer transmits account data to a consumer-selected vendor computer. When a coupon card and selected products are presented to the vendor, the vendor computer discounts the price of the products according to the coupon data on the card and modifies its inventory records as well. Coupons may be redeemed a predetermined number of times prior to a predetermined expiration date.

### BACKGROUND OF THE INVENTION

The present invention relates generally to merchandising systems and, more particularly, to a system by which a consumer may electronically select coupons for redemption a predetermined number of times from a selected vendor prior to an expiration date.

Coupons are a familiar marketing and merchandising strategy by which vendors or retailers offer discounts on particular products so as to boost sales or obtain other market information. While paper coupons are still prevalent, they suffer from the disadvantages of low consumer usage, fraudulent redemption practices, and administrative inefficiency relating to retailers redeeming the coupons with respective manufactures or issuers. Various systems have been proposed in the art for on-line selection of coupons or use of a card having coupon data stored thereon. Although assumably effective for their intended purposes, existing systems do not provide an efficient system having a host computer database of coupon card accounts in communication via a computer network with a user-selected vendor computer database having product and inventory information.

Therefore, it is desirable to have a system for on-line selection of coupons with each participating consumer being associated with a coupon card account in a host computer database. Further, it is desirable for a computer database of a consumer-selected vendor to receive coupon account information from the host computer database. In addition, it is desirable to have a system in which participating consumers receive a coupon card having a personal identification number to facilitate in-store redemption of selected coupons.

### SUMMARY OF THE INVENTION

A system and method according to the present invention includes a first database of coupon card accounts associated with a plurality of portable coupon cards. Each account includes a personal identification number associated with a participating consumer, as well as data representing a plurality of consumer-selected coupons, an expiration date for coupon redemption, and a plurality of redemption numbers representing the number of times a respective coupon may be redeemed prior to the expiration date. Each account also includes a consumer-selected vendor name representing a particular store at which the coupons may be redeemed. Consumers may select desired coupons from a library of available coupons either through a connection between a personal computer and a host computer using a computer network or through a specially adapted point-of-purchase machine electrically connected to the host computer. Once desired coupons are selected and payment therefor is consummated, predetermined account information is magnetically stored on a coupon card and coupon identifiers are imprinted thereon. The card is either dispensed or mailed to the consumer.

Respective coupon account data is automatically transmitted from the host computer to a vendor computer associated with the vendor previously selected by a respective consumer, the vendor computer having a database of received coupon accounts and product inventory information. A consumer seeking to redeem the previously selected coupons takes the coupon card to the point-of-sale location (checkout stand) at the selected store along with the various products to be purchased. The card is scanned to derive the consumer's personal identification number stored thereon such that the vendor computer may access the appropriate coupon account from the vendor computer database. As products are scanned by a bar code reader in the conventional manner, the vendor computer checks the respective coupon account for a matching coupon. If found, the price of the product, also retrieved from the vendor computer database, is reduced accordingly so long as the coupon has not been redeemed more than a predetermined number of times and the coupon has not expired. Finally, the vendor may periodically electronically redeem all consumer-redeemed coupons by electronically transmitting them to the host computer via the computer network.

Therefore, a general object of this invention is to provide a system and method for electronically redeeming coupons.

Another object of this invention is to provide a system, as aforesaid, which allows consumers to select desired coupons from an on-line library of coupons.

Still another object of this invention is to provide a system, as aforesaid, which maintains a database of coupon accounts at a host computer associated with a plurality of participating consumers and respective coupon cards.

Yet another object of this invention is to provide a system, as aforesaid, in which respective coupon account information is transmitted from the host computer to a consumer-selected vendor computer.

A further object of this invention is to provide a system, as aforesaid, which provides a coupon card to each participating consumer that is electronically associated with a respective coupon account.

A still further object of this invention is to provide a system, as aforesaid, which allows selected coupons to be redeemed multiple times at a consumer-selected vendor location prior to an expiration date.

Still another object of this invention is to provide a system, as aforesaid, in which the vendor computer database includes coupon account information received from the host computer and product inventory information.

A further object of this invention is to provide a system, as aforesaid, in which retail vendors can electronically redeem consumer-redeemed coupons through network communication with the host computer.

A still further object of this invention is to provide a system, as aforesaid, in which demographic and other market information is collected from a consumer by the host computer at the time a coupon card is requested.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a consumer selecting coupons at a coupon card point-of-purchase machine according to the present invention;

FIG. 2a is a front view of a portable coupon card according to the present invention;

FIG. 2b is a rear view of the portable coupon card as in FIG. 2a;

FIG. 3 is a block diagram of a method for electronically redeeming coupons using the system and coupon card according to the present invention;

FIG. 4 is a block diagram of a method for obtaining a coupon card; and

FIG. 5 is a block diagram showing the communication between a consumer, a vendor computer, and the host computer.

### DESCRIPTION OF THE PREFERRED EMBODIMENT

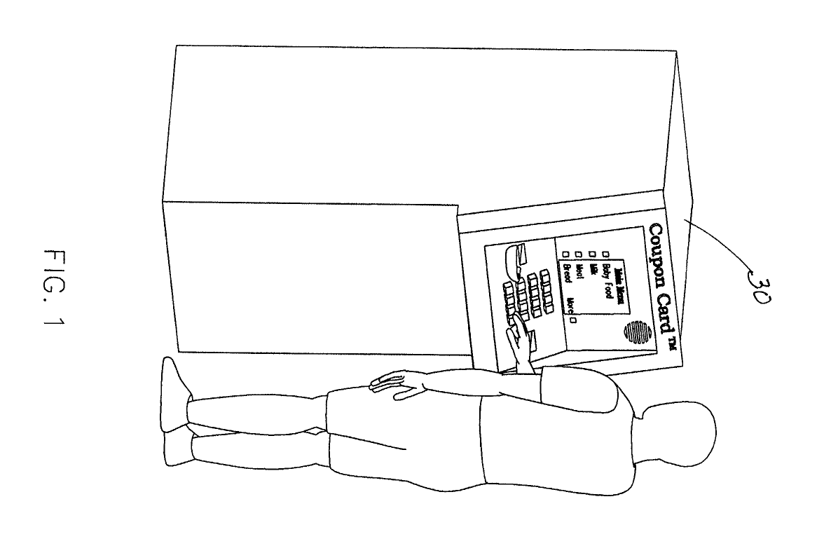

A system and method for electronically obtaining and redeeming coupons according to the preferred embodiment of the present invention will now be described with reference to FIGS. 1-5 of the accompanying drawings.

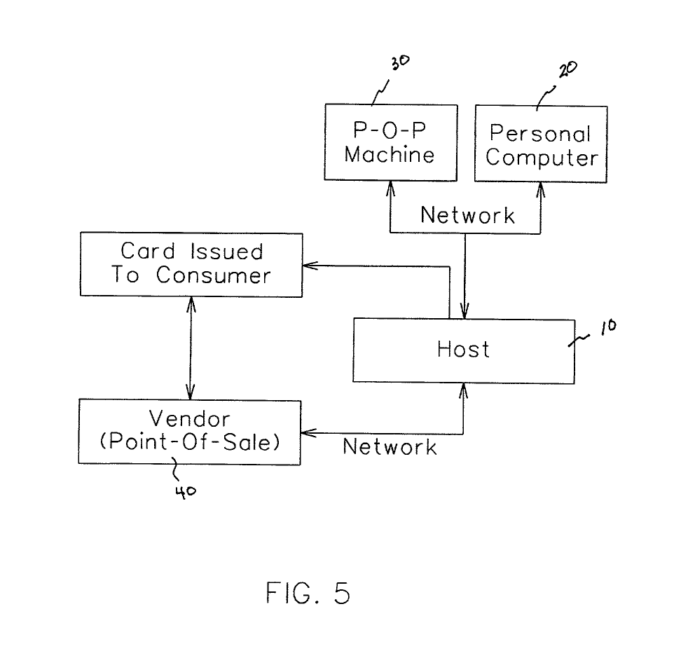

The system according to the present invention includes a host computer 10 having a port connected to a wide-area network such as the Internet (FIG. 5). The host computer 10 is connected to a first database capable of storing data records representing a plurality of coupon accounts, each account corresponding to a plurality of portable coupon cards 50 and respective participating consumers. Each account includes a personal identification identifier associated with a particular consumer, data representing a plurality of consumer-selected coupons, an expiration date by which the selected coupons must be redeemed, a plurality of redemption numbers representing the number of times respective coupons may be redeemed prior to said expiration date, and a consumer-selected vendor. The first database may also include demographic and market information elicited from a consumer at the time a new coupon account is established, as to be described more fully below.

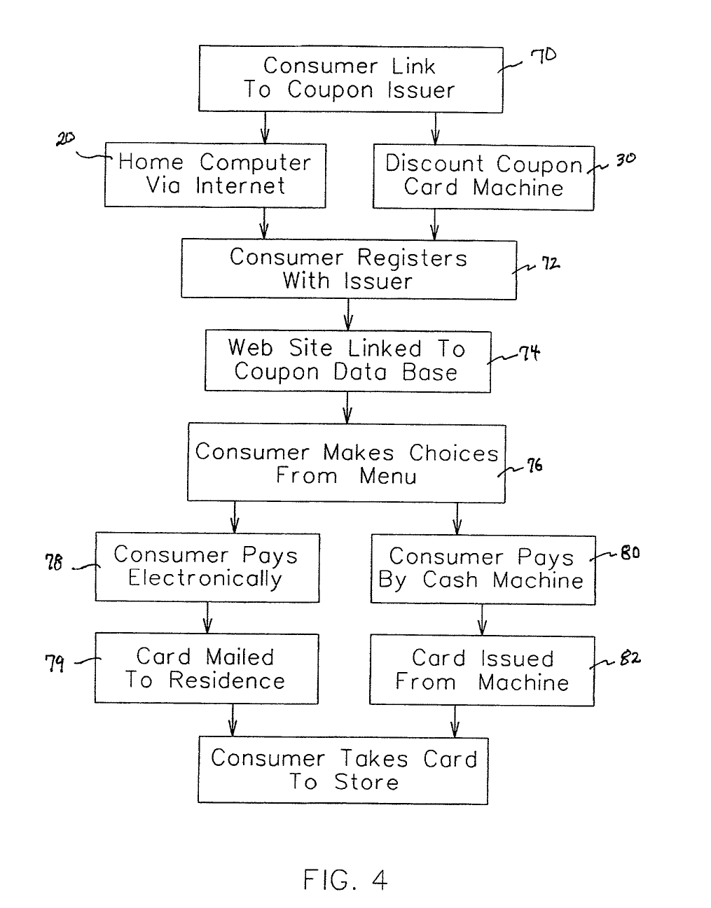

As shown in FIG. 4, coupon accounts may be established when a consumer initiates communication 70 with the host computer 10 either from a remote computer 20 or an ATM-like point-of-purchase machine 30 connected to the host computer 10. A consumer may connect to the host computer 10 with a personal computer 20 utilizing the Internet (FIG. 5) so as to request a coupon card 50. Demographic data such as name, age, occupation, financial condition, etc. may be collected when a consumer registers 72 with the host computer 10 and this data may be used by product manufacturers as a marketing tool. A consumer is then permitted to select desired coupons from an on-line library 74 of available coupons arranged in a menu format 76 (FIG. 4).

When all of the desired coupons have been selected, payment for a coupon card 50 is calculated and the consumer may pay therefor either electronically or conventionally. If payment is maid electronically (i.e. via the network), the selected coupons are imprinted upon the card as further described later and the card is mailed to the consumer, as indicated at blocks 78 and 79. If payment is made conventionally (i.e. in cash when using the point-of-purchase machine), the card is immediately imprinted upon and dispensed to the consumer, as indicated at blocks 80 and 82.

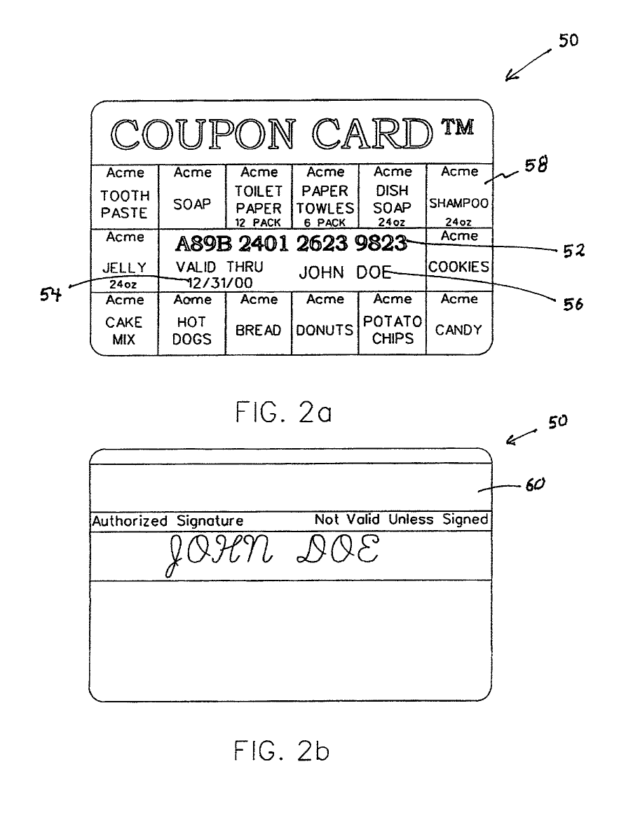

As mentioned above, the system includes a plurality of generally rectangular portable coupon cards 50 (FIGS. 2a and 2b). A front side of a coupon card 50 includes alphanumeric indicia representing a personal identification number 52 associated with a particular consumer and respective coupon account (FIG. 2a). Indicia representing an expiration date 54 and the particular consumer's name 56 are also imprinted on the front side of a coupon card 50. A product identifier 58 representing products associated with each coupon selected by a respective consumer is also imprinted on the front side of a respective coupon card 50. Each product identifier 58 includes a name of a respective company, the name of a respective product or brand name, and a quantity indicator if more than one quantity of the product is offered by the company (FIG. 2a). All of this coupon and identifier information is imprinted upon the front side of a coupon card immediately following selection of desired coupons by a consumer and payment therefor. The back side of each coupon card 50 includes a magnetic strip 60 capable of storing coupon account data. At least the personal identification number 52 which associates the card 50 with a respective coupon account is stored on the strip 60 so that the proper account may be accessed by a retail vendor, as to be further described below (FIG. 2b). It is understood that all or part of the entire coupon account may be stored on a respective card magnetic strip 60.

The system also includes a plurality of vendor computers 40 connected to the Internet for communication with the host computer 10 (FIG. 5). As each coupon account includes a consumer-selected vendor, the host computer 10 is adapted to transmit coupon account data directly to respective vendor computers via the computer network where the consumer-selected coupons will actually be redeemed. Each vendor computer 40 is connected to a database capable of storing coupon account data as well as at least inventory and price information related to all products for sale by the vendor. Each of these types of information is accessed by the vendor computer 40 each time a coupon card is used during a sales transaction at that store.

In use, a consumer who desires to receive a coupon card 50 makes contact with the host computer 10, either through Internet access from a remote personal computer 20 or from a specially adapted ATM-like point-of-purchase machine 30 that is connected to the host computer 10 (FIGS. 1 and 5). The consumer is prompted first to provide certain demographic information and then to select coupons from a library of available coupons arranged in a menu-driven format. All of this information is stored in a coupon account in the first database along with a personal identification number, the expiration date, a redemption number representing how many times respective coupons may be redeemed prior to the expiration date, and the name of a participating vendor where the coupons must be redeemed. If a remote connection has been utilized, then electronic payment must be arranged (e.g. via credit card). A portable coupon card 50 is then imprinted with the assigned personal identification number and product identifiers representing the chosen coupons. At least the personal identification number is stored on the magnetic strip 60 on the back of the card 50.

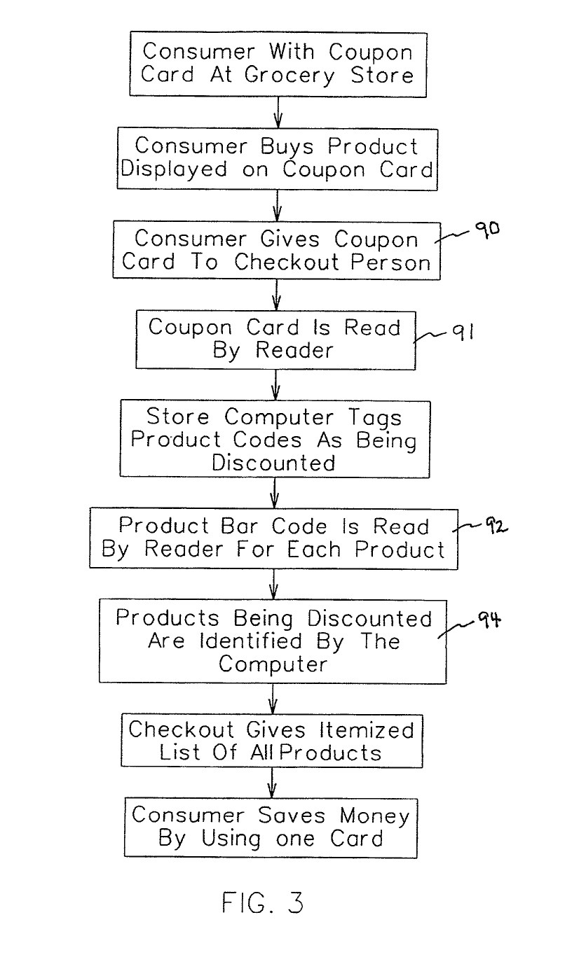

The coupon account data is automatically transmitted via the computer network to the consumer-selected vendor computer 40 and stored in a database connected thereto for access upon presentment of a respective coupon card by the consumer. When the consumer presents the coupon card 50 at a point-of-sale location (i.e. check-out counter) as indicated at block 90 in FIG. 3, it is scanned 91 by a magnetic strip reading device connected to the vendor computer 40 so as to access the corresponding coupon account. Then as products to be purchased by the consumer are scanned by a bar code reading device connected to the vendor computer 40, as indicated at block 92, price and inventory information is retrieved relative thereto. When a product is scanned for which a coupon is found in the relevant coupon account 94, the price is reduced accordingly so long as the expiration date is later than the present date. Further, the price is reduced only if the number of times that the particular coupon may be redeemed is greater than zero. This number is reduced by one in the vendor computer database following redemption thereof. In addition, the inventory information is modified to reflect a sale of the respective product.

Each coupon redemption is separately recorded in the vendor computer database. Periodically, the vendor computer transmits a record of these redemptions to the host computer 10 via the network so as to affect reimbursement therefor (FIG. 5).

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A method for electronically redeeming consumer-selected coupons, comprising:
electronically storing coupon data on a portable coupon card, said coupon data including a plurality of coupons selected by a consumer, an expiration date for redemption of said consumer-selected coupons, a plurality of redemption numbers representing the number of times respective consumer-selected coupons may be redeemed prior to said expiration date;
providing said portable coupon card to said consumer;
electronically scanning a bar code associated with a product selected by said consumer to derive a price and inventory information related to said product;
electronically scanning said portable coupon card of said consumer so as to read said coupon data stored thereon;
reducing said price associated with said selected product based on said coupon data stored on said portable coupon card.

2. The method as in claim 1 wherein said plurality of consumer-selected coupons are selected from an on-line library of available coupons.

3. The method as in claim 2 wherein reducing said price includes reducing said price if a respective redemption number is greater than zero and said predetermined expiration date is later than a present date.

4. The method as in claim 1 wherein providing said portable coupon card to said consumer includes dispensing said portable coupon card from a point-of-purchase machine.

5. The method as in claim 1 wherein providing said portable coupon card to said consumer includes mailing said portable coupon card to said consumer.

6. The method as in claim 1 further comprising establishing a connection utilizing a computer network between a remote computer of a consumer and a host computer for electronically selecting coupon data offered at said host computer.

7. The method as in claim 1 further comprising receiving a payment from said consumer for said portable coupon card following the step of storing said consumer-selected coupon data thereon.

8. A coupon processing system, comprising:
a first database of coupon card accounts associated with a plurality of portable coupon cards, each account including a personal identification number associated with a particular consumer, data representing a plurality of consumer-selected coupons, an expiration date for redemption of said consumer-selected coupons, a plurality of redemption numbers representing the number of times respective coupons may be redeemed prior to said expiration date, and a consumer-selected vendor name;
means for storing respective account data on a respective portable coupon card;
a host computer connected to said first database and connected to a computer network;
a vendor computer connected to said computer network and adapted to communicate with said host computer for receiving account data of a particular account for which said consumer-selected vendor name is associated with said vendor computer;
a second database of information related to a plurality of vendor products, said vendor product information including at least a price and inventory information related to each vendor product;
wherein said vendor computer is electronically connected to said second database;
means electrically connected to said vendor computer for reading said account data stored on said respective portable coupon card; and
means electrically connected to said vendor computer for identifying a particular vendor product selected by a consumer for purchase, said vendor computer adapted to modify said inventory information in said second database based on a sale of said particular product and to calculate a final purchase price of said particular product based on said account data read from said respective portable coupon card.

9. The coupon processing system as in claim 8 wherein said vendor computer is adapted to transmit coupons redeemed electronically by consumers to said host computer utilizing said computer network for redemption thereof with the issuer of said coupons.

10. The coupon processing system as in claim 8 wherein said host computer is adapted to receive a request from a remote computer connected to the computer network for establishing a new coupon card account in said first database, said host computer adapted to transmit signals for eliciting predetermined demographic information from a new user at said remote computer and prompting said new user to choose a new plurality of consumer-selected coupons from a library of on-line coupons, said host computer adapted to assign a new personal identification number to a new record and store said demographic data and new plurality of consumer-selected coupons in said new record in said first database.

11. The coupon processing system as in claim 8 wherein said vendor computer is adapted to retrieve a respective price from said second database associated with a particular product identified by said identifying means and to reduce said respective price by an amount equal to a respective coupon identified by said reading means if a respective redemption number is greater than zero and said expiration date is later than a present date.

12. The coupon processing system as in claim 11 wherein said vendor computer is adapted to reduce said respective redemption number by one if said respective coupon is redeemed.

13. The coupon processing system as in claim 8 wherein said identifying means is a bar code reader.

14. A transaction instrument, comprising:
a generally rectangular card having an alphanumeric identification code imprinted on a first side thereof and a plurality of product identifiers imprinted on said first side, said plurality of product identifiers representing a plurality of consumer-selected coupons; and
a magnetic strip on a second side of said card, said magnetic strip adapted to store data representing at least said plurality of consumer-selected coupons and said personal identification number.

15. A transaction instrument as in claim 14 wherein each product identifier includes a name of a respective company, a respective product or brand name, and a quantity indicator if more than one quantity is offered by said company.

16. A transaction instrument as in claim 14 wherein said strip is adapted to store data representing an expiration date for redemption of said consumer-selected coupons, a plurality of redemption numbers representing the number of times respective coupons may be redeemed prior to said expiration date, and a consumer-selected vendor name.

17. The transaction instrument as in claim 14 wherein said card is dispensed by an ATM machine upon pre-payment of a monetary amount based on a value of said consumer-selected coupons.
